(19) United States
(12) Patent Application Publication
(10) Pub. No.: US 2005/0002323 A1
(43) Pub. Date: Jan. 6, 2005

(54) Cellular network system and method

(76) Inventor: Zion Hadad, Rishon Lezion (IL)

Correspondence Address: ZION HADAD, 48 HAALMOGIM ST, RISHON LEZION, IL

(21) Appl. No.: 10/844,519

(22) Filed: May 13, 2004

(30) Foreign Application Priority Data
May 9, 2003 (IL) 155829

(51) Int. Cl. H04J 11/00; H04Q 7/00

(52) U.S. Cl. 370/203; 370/329

(57) ABSTRACT

A Cellular network system wherein the physical layer as defined in 802.16a includes means for its optimization for mobile operators for improved reliability, coverage, capacity, user location, fully scalability, and mobility from 2-6 Ghz, while working in a reuse of 1. The same RF frequency is allocated to all sectors in the cell. The system further includes means for its operation in a Coordinated Synchronous mode, wherein permutations, collisions and averaging interferences from other cells cause limitations on the use of high QAM modulations, which sometimes can increase capacity up to three times (64 QAM instead QPSK).

### FIELD OF THE INVENTION

This invention relates to same frequency wireless cellular networks, and more particularly to such systems having improved frequency reuse.

### CROSS-REFERENCE TO RELATED APPLICATIONS

The present application is related to, and claims priority from, the patent application No. 155829 filed on 9 May 2003 in Israel, and the PCT application No. PCT/IL 2004/000386 filed on 9 May 2004, both entitled “Cellular network system and method”

### BACKGROUND OF THE INVENTION

Cellular networks are required to accomodate an ever increasing number of users. The total allocated frequency bandwidth, however, is limited. Thus, as the number of users increase, there may be interference between users.

As more users share the channel, the interference level may increase; likewise the problem aggravates when users demand a larger bandwidth, as they frequently do.

The interference problem is more difficult to solve in novel OFDMA systems, wherein adjacent base stations use the whole channel. In older FDMA systems, the channel is separated into disjoint sub-channels. These channels may be allocated separately, wherein in each allocation only part of the bandwidth is used. Filtering, together with different channel allocation for each BS, can be used to reduce interference.

In the new OFDMA systems however (for example, as described in IEEE 802.16a or in EN-301-958), the channel is separated into sub-channels, wherein each sub-channel is spread over the entire bandwidth. This scheme achieves improved frequency diversity and channel usage (no need for frequency separation between sub-channels).

For example, in a system according to IEEE 802.16 for mobile applications, the basic synchronization sequence is based on a predefined sequence of data that modulates a subset of the sub-carriers. Sub-carriers belonging in this subset are called pilots and are divided in two groups.

One group is of fixed location pilots and the other is of variable location pilots. There is a variable location pilot every twelve sub-carriers, and it is changing position each OFDMA symbol with a cycle repeating every four OFDMA symbols. This is the method used in the IEEE 802.16a OFDMA basic synchronization sequence.

The pilots in OFDMA are used for synchronization as well as for channel estimation, so it is essential to prevent or reduce interference on these sub-carriers, to achieve a high performance downlink.

A PMP sector contains one Base Station (BS) and multiple Subscriber Units (SU). The network topology shall contain multiple BSs, operating within the same frequency band. The transmission from the BS to the SU is referred as Downlink, and the transmission from the SU to the BS is referred as Uplink.

The bandwidth of each user may be limited or reduced, despite the fact that users demand more and more bandwidth—there are new applications which require a wide bandwidth.

The cellular environment is dynamic—at one instant in time, a multitude of users may gather in one place, overloading the system, whereas in another location the allocated channel may be idle or not operating to capacity.

Present systems may waste resources by not being able to adapt and respond fast to the changing environment.

In a wideband system, there is also the problem of precise synchronization between the mobile devices and the base station. Inefficient synchronization may reduce the performance of the cellular network.

It is an objective of the present invention to overcome various problems for achieving better spectrum utilization in cellular wireless networks.

### SUMMARY OF THE INVENTION

According to the present invention, there is provided a system and method for more efficient use of the spectrum in same frequency wireless cellular networks.

The present invention is devised for wideband communication systems, for example cellular point-to-multipoint (PMP) networks, operating within the same frequency channel.

A PMP sector may contain one Base-Station (BS) and multiple Subscriber Units (SU). The network topology may contain multiple BSs, each controlling one or more PMP sectors. The transmission from the BS to the SU is referred as Downlink, and the transmission from the SU to the BS is referred as Uplink.

Improvements for the OFDMA PHY layer and PMP network topology are disclosed, which are suitable both for fixed and mobile environment and provides method of using multiple BS transmitters operating in partially overlapping areas using a single frequency channel for downlink transmissions for all the BSs/sectors.

The improvement may be applied to the IEEE 802.16 standard, to include changes to the OFDMA system, which will allow it to work in a very fast mobility (up to 200 Km/h in the 2.7 GHz band) scenario as well as in a frequency reuse of 1 scenario.

The system will also support better granularity (down to 6 bytes).

Further objects, advantages and other features of the present invention will become obvious to those skilled in the art upon reading the disclosure set forth hereinafter.

### BRIEF DESCRIPTION OF THE DRAWINGS

FIG. 1 illustrates a regional coverage with wideband cells

FIG. 2 details a base station with six sectors and its groups allocation.

FIG. 3 details a base station with three sectors and its groups allocation.

FIG. 4 details a base station with six sectors and its groups allocation.

FIG. 5 illustrates SFN operation with 6 groups OFDMA.

FIG. 6 illustrates SFN operation with 3 groups OFDMA.

FIG. 7 details a Downlink transmission basic structure

FIG. 8 depicts as an example the preamble of sector 1

FIG. 9 illustrates downlink symbol structure for sector 1

FIG. 10 details Mini Sub-Channel (of 21 carriers) organization and structure

FIG. 11 details Mini Sub-Channel (of 21 carriers) organization and structure

FIG. 12 illustrates Burst Structure using regular sub-channel

FIG. 13 details the structure of a wideband mobile transmitter was 5 handoff

FIG. 14 details the structure of a wideband mobile receiver

FIG. 15 details the structure of a wideband base station transmitter

FIG. 16 details the structure of a wideband base station receiver

FIGS. 17(A) and 17(B) detail a channel estimation and correction system.

FIG. 18 illustrates packets flow through an access point.

FIG. 19 illustrates packets flow through a MAC link.

FIG. 20 details an antenna allocation scheme

FIG. 21 details CDMA an initial ranging method

FIG. 22 details CDMA an initial ranging method—SS (part 2)

FIG. 23 details CDMA an initial ranging method—BS

FIG. 24 details a periodic ranging method

FIG. 25 details an implementation of AAS support

FIG. 26 details a method for mapping OFDMA slots

FIG. 27 details a method for mapping OFDMA slots

FIG. 28 details a time plan for one TDD time frame

FIG. 29 illustrates an OFDMA frame

FIG. 30 details a method for FCH channel allocation

FIG. 31 details a method for renumbering the allocated subchannels

FIG. 32 details a method for renumbering the allocated subchannels

FIG. 33 details a method for STC usage

FIG. 34 details a method for STC usage with OFDMA for PUSC

FIG. 35 details an allocation method for AAS_DL_Scan

FIG. 36 details a mapping order for fast feedback

FIG. 37 details mapping of MIMO coefficients

FIG. 38 details a cluster structure

FIG. 39 details useful data payload for a subchannel

### DETAILED DESCRIPTION OF THE PREFERRED EMBODIMENTS

A preferred embodiment of the present invention will now be described by way of example and with reference to the accompanying drawings.

The new system and method are applicable both in TDD and FDD.

Reuse of 1 Method

When using a reuse factor which is >1 (regular scenarios defined in the 802.16a) the same physical layer defined in the 802.16a can be used for the 802.16e. To be optimized for mobile operators requirement such as Reliability, coverage, capacity, user location, fully scalability, and mobility from 2-6 Ghz, the system is configured to work in a reuse of 1, which means the same RF frequency is allocated to all sectors in the cell, then enhanced scheme of work is introduced in order to achieve the needed performance (capacity, coverage, etc . . . ).

The system is supporting three levels of reuse 1: asynchronous, Synchronous and Coordinated Synchronous.

1. Where in the Asynchronous case the system using any ref ck for creating the frames in that case each BS is using different permutations and collision between two users is happening throw frequency shift of the BSs and time shifts between frames, Inside the BS the sub channels are orthogonal, between BS/Sector the fact that each BS using different permutations per sub channel and different randomizers on the data create a controlled collision between the different BS users where few sub carriers collision are happening (kind of averaging the interferences from other cells).

With our FEC, this enables the system to operate with a reasonable capacity but with limited coverage like 90%, this system might used by operators that want to have fast and low cost reasonable coverage with longer HO time (TDD mode might use the 802.16 time stamp in order to synchronize the frames and UL/DL timing between BS and different operators).

Each BS sector is using more Sub channel as he need up to the point that the SNR (sub carrier collision) is dropping below some reference TH, this system is supporting a BW shared by different BS, for example if there is temporary hotspot traffic area in one of the sectors he might use more sub channels on the expense of the un used number of sub channels in the other sectors.

2. In the Synchronous case a more accurate reference ck may be provided (by GPS for example) and the BS may be synchronized by frames and by OFDM symbols (which is easier in the case of higher FFT sizes, the frame # will be synchronized by GPS or time stamp, the advantages hear is that the orthogonality between sub carriers is maintained in the BS/Sector and between different neighbors BS/sectors.

The reason for this is because of the higher FFT size and the bigger GI a 20 us can give 6 km different in time of arrival to the user) this Synchronization will enable fast H.0 time and soft H.0 in the physical level and smooth H.0 on the mobile IP level (no loss of packets at layers 2-3).

3. Coordinated Synchronous—The case of permutations and collisions and averaging interferences from other cells causing limitations on the use of high QAM modulations, which in our case sometimes can increase capacity up to three times (64 QAM instead QPSK).

In that case, we are using the same permutations for a group of BS/sectors and a sector/BS are coordinate sub channels division between them by communicate throw the back bone. This approach might increase the capacity by factor of 1.5 on the same coverage area with a probability higher than 99%.

The IEEE standard may implement all the three which basically means implementing the last one where the others are subsets of it.

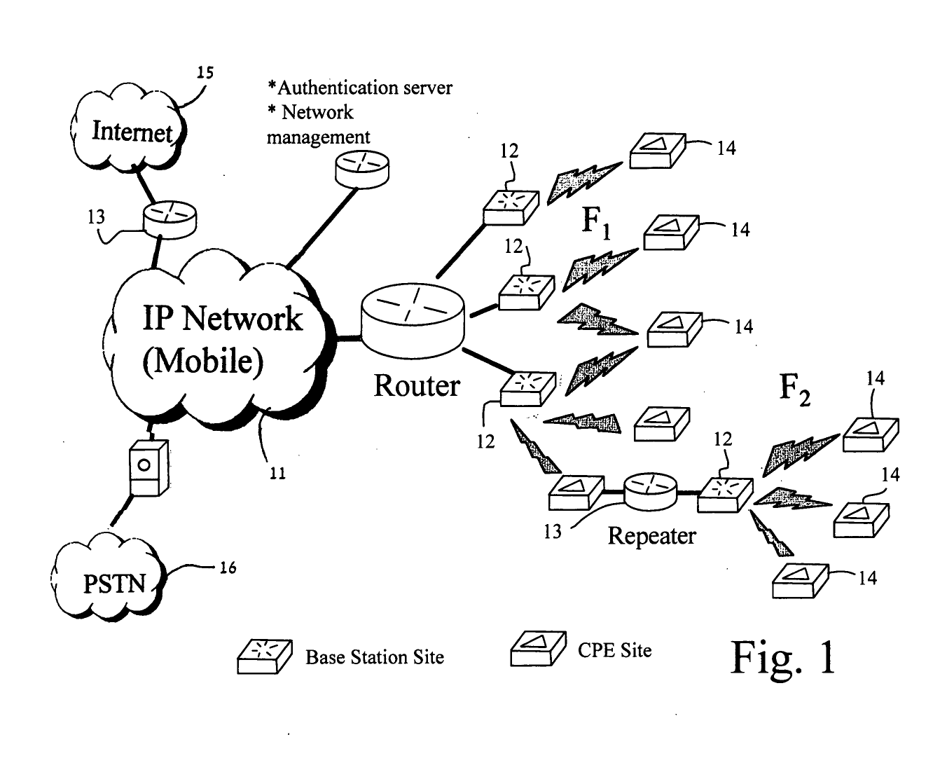

FIG. 1 illustrates a regional coverage with wideband cells, connected through a mobile IP network 11. The network 11 is connected to base stations 12, possibly through repeaters 13.

The base stations 12 connect to the CPE sites 14.

The mobile network 11 may also connect to the Internet 15 and/or a PSTN 16.

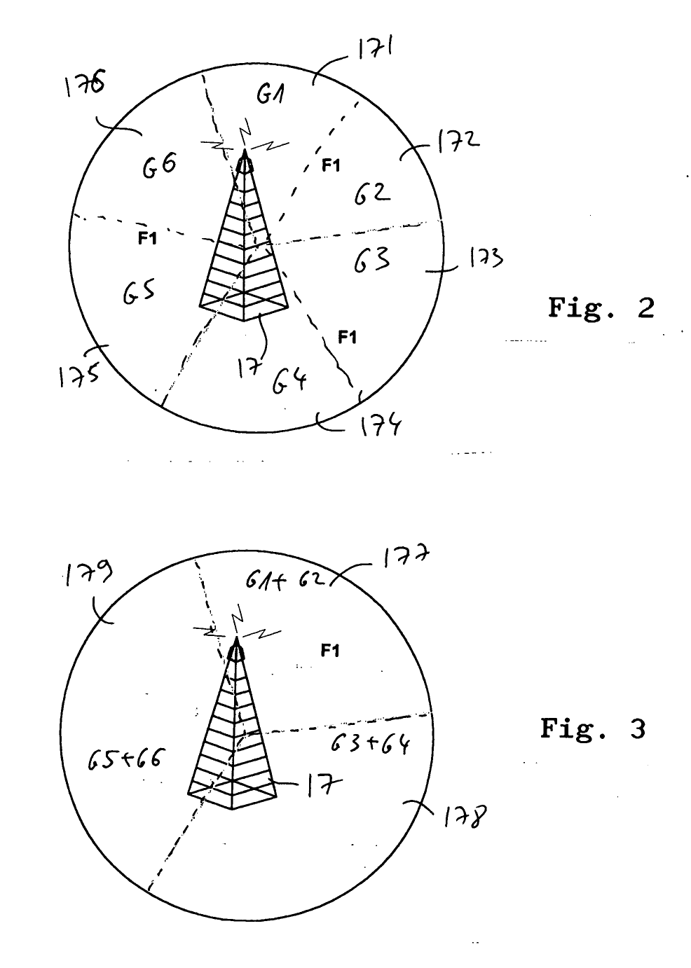

FIG. 2 details a base station 17 with six sectors 171, 172, 173, 174, 175, 176. The wideband channel is divided into six groups, with each sector being assigned a group: G1, G2, G3, G4, G5, G6 respectively.

Each group comprises a plurality of subcarriers, as detailed elsewhere in the present application. The groups need not contain an equal number of subcarriers.

The advantage of this allocation method is good isolation between sectors, preventing interference therebetween. The disadvantage is a relatively narrow bandwidth in each sector—just a sixth of the available bandwidth, for an equal division among sectors.

FIG. 3 details another embodiment, of a base station 17 with three sectors 177, 178, 179, with each sector being assigned a wider channel group: G1+G2, G3+G4, G5+G6 respectively.

Each sector is assigned a wider bandwidth, at the expense of more subscribers per sector. Such an allocation may be used when the subscribers distribution permits it.

Method Using a Reuse of 1

FIG. 3 illustrates a Reuse of 1 configuration, 3 sectors per cell There are two options to work in this scenario:
Each sector uses the entire band, as in regular operation; this method suffers for a high level of interference, low throughput and bad coverage
Each sector uses some of the sub-channels; the division of the sub-channels is orthogonal within the base-station. This method avoids the high level of interference, the used bandwidth per sector is smaller but the spectral efficiency for each sector is high (as in regular coverage scenarios).

The preferred scenario is of course the second one (which is also used CDMA systems, where codes are divided between the base-stations), such a scenario is presented in FIG. 4.

FIG. 4 details a base station 17 with six sectors 171, 172, 173, 174, 175, 176, with each sector being assigned a wider channel group: G1+G2, G3+G4, G5+G6 respectively.

This configuration uses the front-to-back ratio of the antennas at the base station, to isolate between opposite sectors. Thus, opposite sectors can use the same subcarriers group, to increase the available bandwidth in each sector.

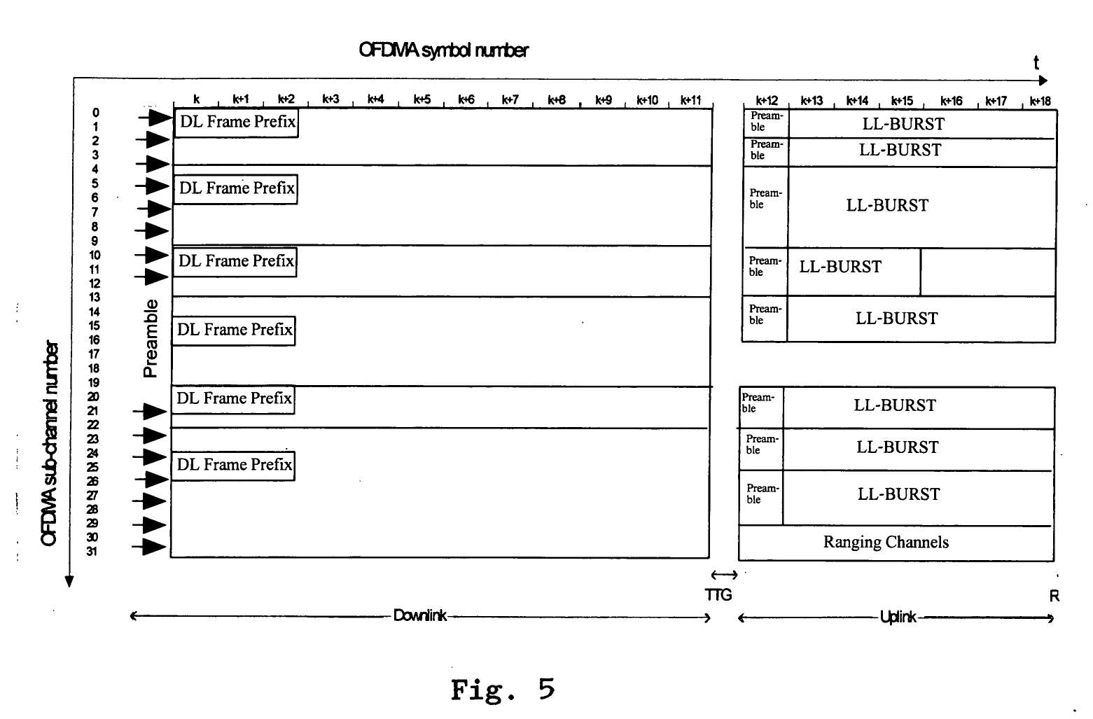

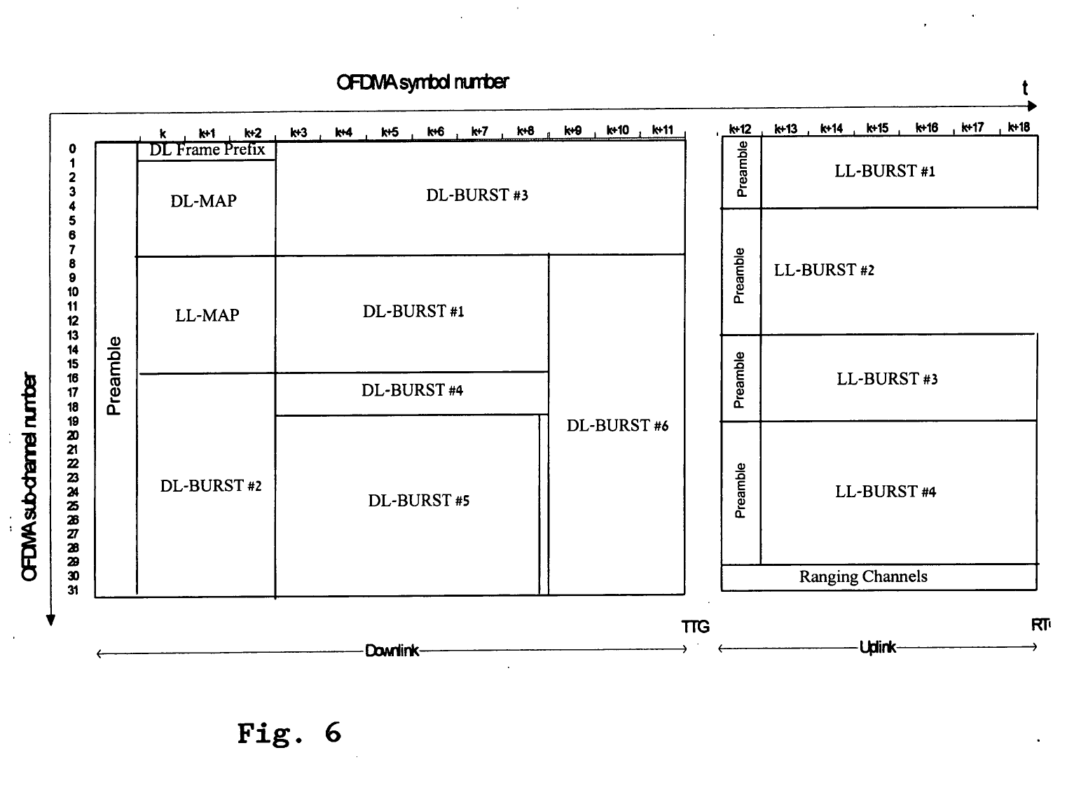

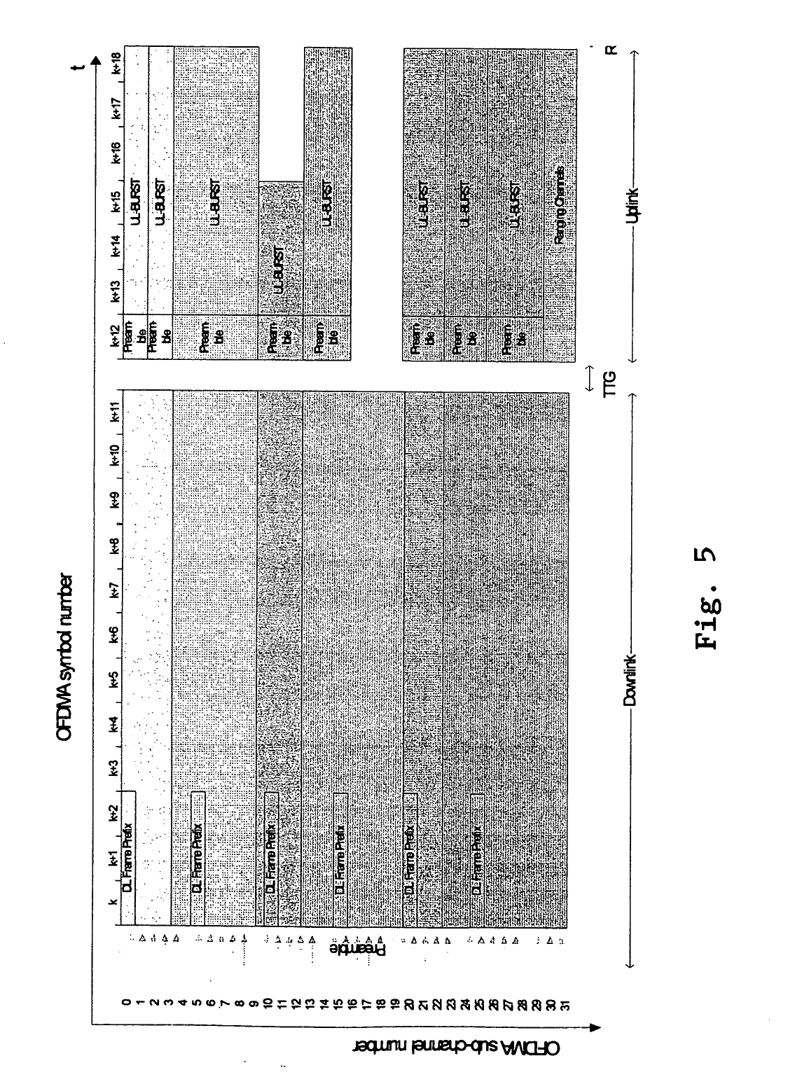

FIG. 5 illustrates SFN operation with 6 groups OFDMA.

FIG. 6 illustrates SFN operation with 3 groups OFDMA.

Improvements in Wideband Subcarriers Allocation

Improvement—in preamble, each sixth is a jump in pilots. Can be used in SFN or Reuse one—same frequency is reused.

A subscriber receives several signals: six from the closest (best reception) at highest power; six each from other base stations, at lower power.

The pilots are divided among neighbor base stations, 6 to each/every six in subgroups.

Each subscriber performs channel estimation using pilots allocated to each base station, for the channel with each base station which is received.

The range to each base can be estimated from the roundabout time, and/or from the pilots phase rotation as detailed elsewhere in the present disclosure.

Non contention between base stations is achieved, as each BS uses a different subgroup of pilots.

The receiver includes means to compute a quantitative indicator of performance, for example:
SNRi—signal to noise ratio
CHESTi—Channel Estimator for channel i, and/or
SIRi—signal to interference ratio

As a subscriber moves about in the area, it continuously evaluates SNR to each base station it can receive. Other measures of channel quality can be used as well.

If another base is better—then the subscriber will switch to that base station.

Soft Handoff—receives two or more base stations, then decides to switch from one to another.

Subscriber knows his location from two or more distances (two may give two locations—ambiguity; three base stations solve the ambiguity and improve precision of location).

The transmitted signals have a guard time interval. Thus, even if the FFT timing is not precise, it will not include adjacent OFDM symbols.

Time measurements can be performed by FFT on pilots. If the sampling is precisely on time, then the pilots are in phase. A time delay results in rotation of pilot phasors, which is indicative of the time difference relative to the desired timing.

From time measurements—the range (distance) can be computed. From two or more ranges to base stations—the mobile location can be found.

Implementation: large FFT, large dynamic range—will include the strongest signal from a base station, and also one or more weaker signals, from other base stations. If dynamic range is too small—then weaker signals will be supressed because of the quantization error.

In one embodiment—ADC use 10 bits, with a suitable bus width FFT. The FFT may be 1024 point for example.

Modified Wideband Channel

According to the invention, unambiguous synchronization of each SU in each cell can be achieved by a novel system wherein all BSs are synchronized in frequency and time, having the same Frame numbers and slot index, and the same reference clock like GPS or other external synchronization mechanism, which creates a macro-synchronized system for control purposes.

Such an OFDMA system may use the property, that the sub-channels are shared between different BSs.

Furthermore, a large FFT (long OFDM symbols, with duration of at least 4 time than the cell radius electromagnetic propagation time) can be used, to create a large enough Guard Interval (GI), which enables ability of proper reception of information from several BSs in parallel while using same RF receiver and same FFT for all BSs.

Unambiguous synchronization of each SU in each cell can be achieved by a method including transmitting a modified synchronization sequence from each BS.

The BS share a common frequency/timing reference, derived for example from GPS, although other techniques may also be used.

A method for interference reduction will now be detailed, that may be advantageously used to improve performance in IEEE 802.16 in mobile applications, for example.

See FIGS. 5 and 6, for an embodiment relating to four base stations. The pilots may be shared as detailed above referring to OFDMA.

In a preferred embodiment, the pilots retain their position as defined in the IEEE 802.16a specification.

Method for Interference Reduction

Following is an embodiment of a method for interference reduction, that may be used in the IEEE 802.16 or other technologies.

1. Synchronize the BS symbol index to a common reference. For example, a global reference may be used, such as GPS. When using GPS, each BS assumes that symbol indexed 0 has occurred in a predefined time in the past (e.g. 1-1-1990 at 00:00.00). The same OFDMA symbol length must be used in all BS. In another embodiment, a local reference may be used, common to just the base stations in a specific network.

2. Assign to each BS an index in the range 0 to N.

3. Allocating a subset of the synchronization sequence to each BS. Each BS will use its index to determine which subset to transmit. The transmission is synchronized with the other base stations as all the base stations are synchronized to a common reference.

These subsets are predefined and known to all BS and SU.

Each BS may broadcast the network topology to all the SUs, such information contains details about the neighbors cells/sectors, what other frequencies are in use in neighbor cells, or which resources (like sub-channels) are free to be used (for example in Hand Over procedures).

4. The subsets of the synchronization sequence may be disjoint.

5. There may also be a sharing in the time dimension where several BS transmit a synchronization sequence with overlap in the frequency domain, but never do it on the same OFDMA symbol.

6. At the SU allow synchronization on each of the subsets. This is possible as long as
Npilots_in_subset/(Subcarrier_Spacing_{—}NFFT)>Tchannel_delay
End of method.

The BS keeps track, for each SU, or generally for the downstream channel, of the sub-carriers having a low SNR and of those having a high SNR value. Based on this information, the BS can do one of the following:
a. Not modulating information on carriers that has low SNR
b. Power boosting of the faded carriers on the account of good carriers (done on a user basis).

The receiver in the SU can learn the channel characteristics from the pilots, thus knowing which carriers were boosted, this enabling it to reconstruct the information precisely.

Doing the procedure above for several SU simultaneously, each with different channel behavior, will achieve more efficient power transmission, since this scheme deal with inter sub-channel adaptation, i.e. with low number of sub-carriers that are spread over the band, the transmission is optimized to any channel delay spread behavior.

Adaptive Allocation Method

In an embodiment of the proposed invention, the following adaptive allocation method is used:

1. Coordination between BS for sub-channel allocations, allocation of sub-channels to a BS (number of sub-channels) according to usage load, and traffic profile in the BS.

2. Coordination between BSs of which sub-channel to allocate to which BS. For more efficient Hand-Over procedure.

3. Data and Pilots organization into a sub-channels:
a. Taking the variable pilots and performing the allocation while shifting through time.
b. Fixed pilots are equally divided between the base-stations and are transmitted all the time.

4. Allocating the variable pilots in frequency domain.

5. Separation between different base-stations by using a different Pseudo Noise sequence on the pilots per each Base Station.

6. Usage of Forward Automatic Power Control (FAPC) in the downstream direction.

7. Downlink Adaptive modulation in OFDMA systems.

8. Selective transmission of sub-channels and pilots in the downstream channel, and not using the whole frequency.

9. Selective transmission of sub-carriers within a sub-channel (Downstream) for TDD systems
a. Not modulating information on carriers that has low SNR
b. Power boosting of the faded carriers on the account of good carriers—done on a user basis.

10. Selective transmission of sub-carriers within a sub-channel (Upstream)—for TDD systems. The SU performs steps 9a and 9b when transmitting information to the BS in the uplink direction.

11. Selective transmission of sub-carriers within a sub-channel—Downstream or Upstream for TDD or FDD systems, by using a closed loop procedure.

12. In OFDMA PMP system which are used for mobile environments, and the uplink and downlink channels are allocated, by using an uplink and/or downlink mapping message:
a. A SU may agree on a sleeping interval with the BS, this defines a time interval in which the SU will not demodulate any downstream information.
b. If the BS has information to the SU, it may either discard the information or buffer it and will send it to the SU in its next awakening point (expiration of the next sleeping interval timer).
c. In the awakening times, the BS may assign the SU a specific allocation for synchronization purposes.

The SU may return to normal operation mode in the frame following the awakening frame.

13. Employing Mobile IP protocol over OFDMA PHY layer.

The different frequencies bands in a Multi Frequency Network (MFM) are collected to one Broadband Frequency Network (BFN).

Sub-Channels (30) are divided up to 6 Logical-Bands within (BFM).

The structure enables each Logical-Band to have the frequency diversity properties of the full channel band, but using only a part of the frequency carriers, this will enable the work in a Single Frequency Network (SFN)—reuse of 1.

Sub channels can be shared by other BS and/or Sectors. This requires communications between cells/sectors.

Extra sub channel splitting is optional, and will enable to boost the transmitted carriers at the expense of the un-transmitted carriers (7.7 dB) (will require extra MM resources) and small granularity (24 symbols).

The current DL pilots are divided between up to 6 orthogonal sectors or three. Each pilots group has 6 different whitening PN.

In STC (optional) system each antenna has its own pilots total orthogonal cells/sectors is reduced to three.

A granularity in OFDMA of 48 or 64 can be used, using CTG—continuous Turbo code. Usable for standard IEEE 802.16E, for example.

There is a preamble, which is divided into 6 groups/clusters.

Each cluster contains pilots, which are distributed over the whole available spectrum.

The preamble with subcarriers is arranged so that G subcarriers allocation into groups: in IEEE there are 32, then 5.

The allocation needs not be into equal parts—it can change dynamically, responsive to demand in each base or base sector.

The system further includes means for facilitating interactions between base stations, to negotiate in real time a subcarriers allocation according to capacity demand in each base station or sector therein.

Thus, subcarriers are transferred from one base station or sector, to another.

The negotiation between base stations can be performed throught the cellular backbone. It may include the stages of demand, negotiation, reports on changes in allocation of subcarriers. The results are communicated to the mobile units, to set them up responsive to the changing subcarriers allocation.

Third Case of Allocation:

Using front-to-back ratio of antenna to separate transmissions, then same subcarriers may be used in sectors in opposte directions.

If using 3 sectors—then 2 groups of subcarriers, separating also by front-to-back ratio in antennas

Space-Time Coding

A base station transmits from 2 antennas to a subscriber, at two locations.

This can be used for STC—space-time coding, transmit diversity.

Used for Channel Estimation

6 groups of pilots, each through 2 antennas to a subscriber
R1-R6
G1-G6 groups

Each antenna uses a different group of subpilots.

In FFT—all are received and processed.

Using 2 antennas, the received can find channel estimates P1, P2—each with a different antenna.

The channels can be distinguished, as P1, P2 use different pilots. but then transfer data units X1, X2.

PHY Definition

The following section deals with the PHY layer specification for the reuse of 1 scenario.

Down-Link Method

The downlink supports up to 3 sectors and includes a preamble which begins the transmission, this preambles divides the used carriers into 6 sections, each 2 sections are used by a single sector, the motivation of this split is to allow the usage of 6 different preambles in the Space-Time Coding mode (STC).

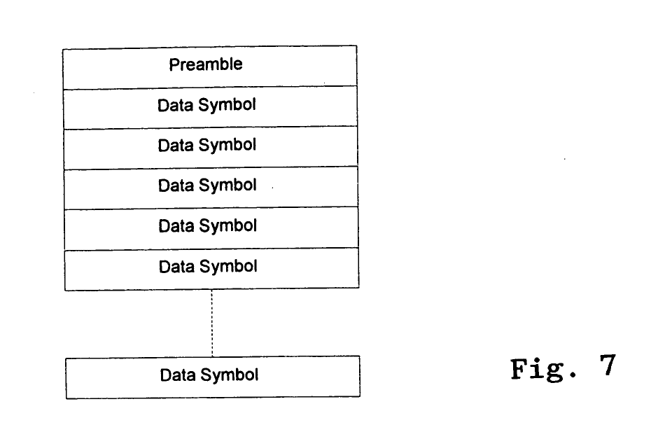

An example of a downlink period is illustrated in FIG. 7. It includes:

1. Preamble

The first symbol of the down link transmission is the preamble; there are 6 types of preambles. The preamble types are defined by allocation of different sub-carriers for each one of them; those sub-carriers are modulated after that using a non-boosted BPSK modulation with a specific Pseudo-Noise (PN) code.

The preambles are defined using the following formula:

where:

specifies all carriers allocated to the specific preamble
specifies the number of the preamble indexed 0 . . . 5
is a running index 0 . . . 283/284 (the index is used while carrier number is ?1702 [symbol] overall used carrier index)

Each sector uses 2 types of preamble out of the 6 sets in the following manner:
Sector 1 uses preamble 0 and 3
Sector 2 uses preamble 1 and 4
Sector 3 uses preamble 2 and 5

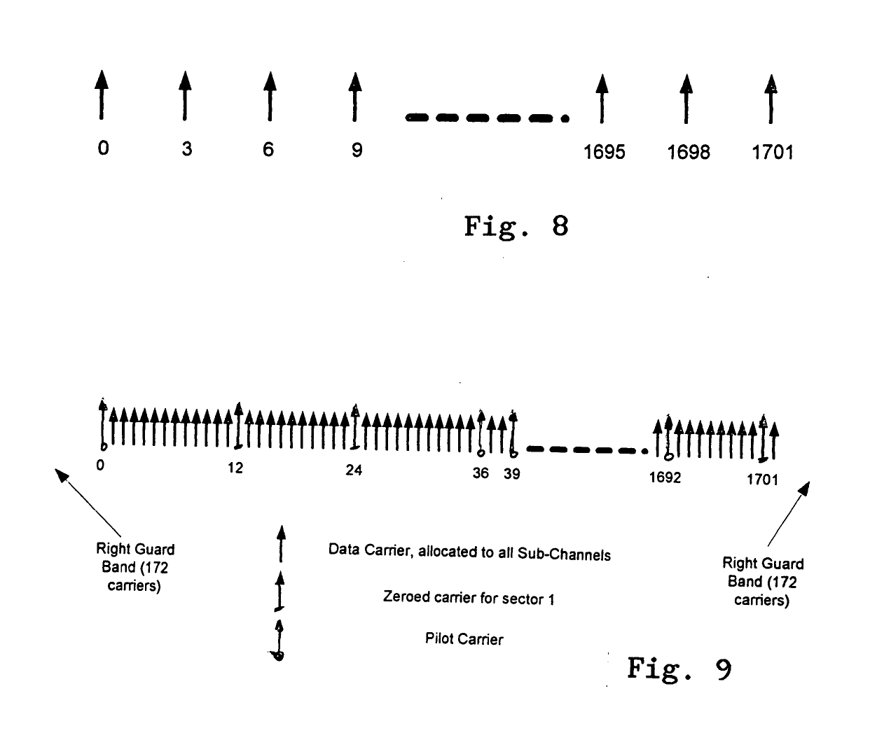

Therefore each sector eventually modulates each 3'rd carrier, FIG. 8 depicts as an example the preamble of sector 1.

The PN series modulating the pilots is the one defined in section 8.5.9.4.3 of the IEEE802.16a. The initialization sequence for each preamble type is given in Table 1.

The modulation used on the preamble is in section 8.5.9.4.3.1 of the IEEE802.16a, therefore the number of combination of PNId and preambles types are 9.

2. Symbol Structure

The symbol structure is constructed using pilots, data and zero carriers. The symbol is first allocated with the appropriate pilots and with zero carriers, and then all the remaining carriers are used as data carriers (these will be divided into sub-channels).

There are 6 possible allocations of pilots, in regular transmission each sector shall use 2 allocations each, in STC mode each antenna uses one out of those two, Table 2 summarizes the parameters of the symbol.

For regular transmission Each sector uses both types of antenna pilots for its transmission, therefore:
Sector 1 uses 56 pilots
Sector 2 uses 55 pilots
Sector 1 uses 55 pilots

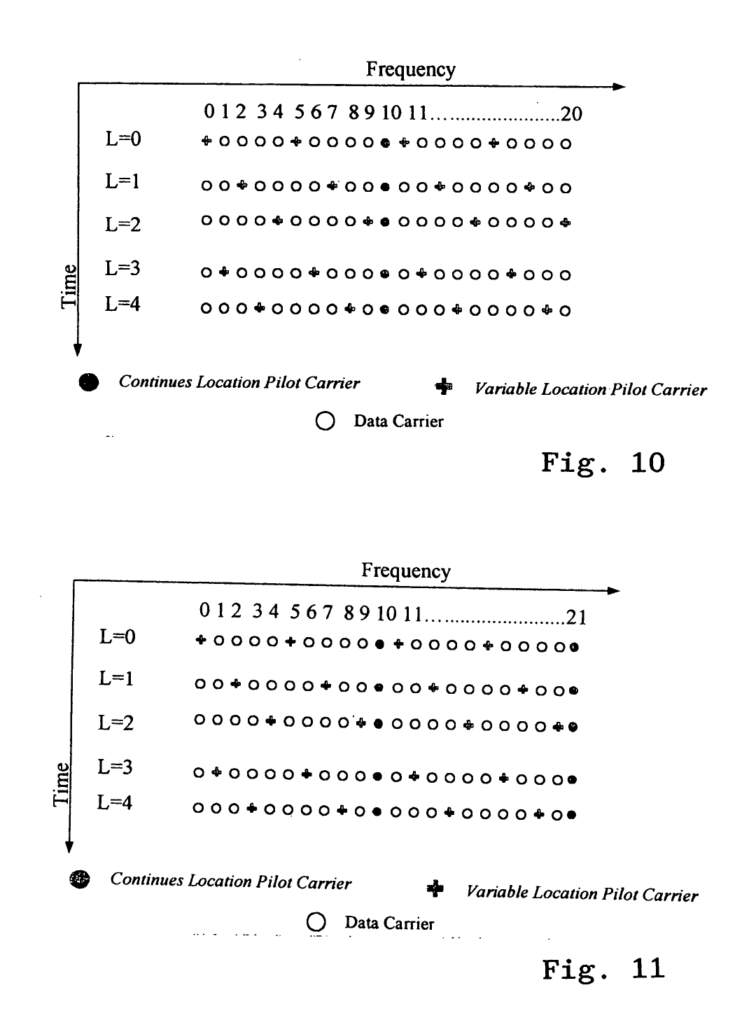

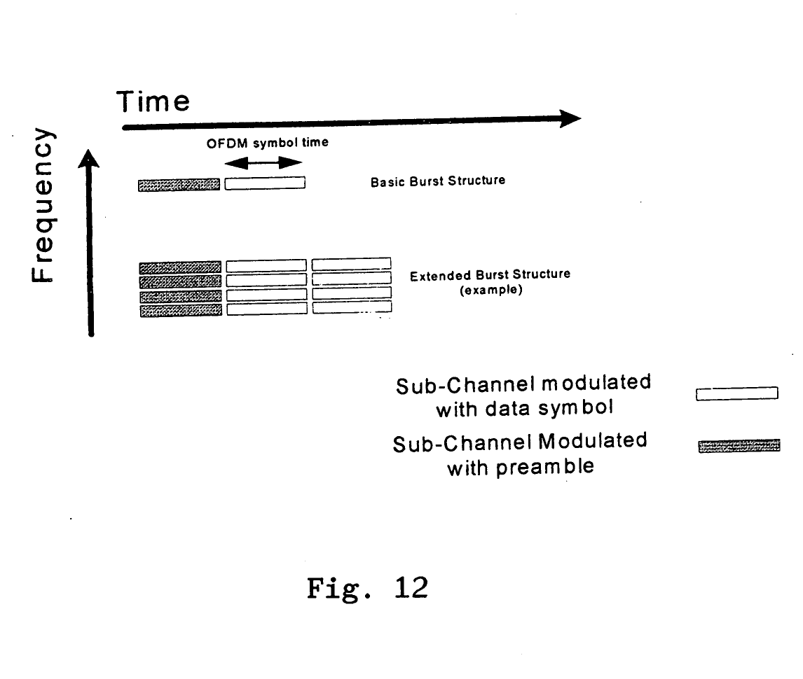

FIG. 9 depicts as an example of the symbol allocation for sector 1.

The PN series modulating the pilots is the one defined in section 8.5.9.4.3 of the IEEE802.16a.

The initialization sequence for each Sector type is given in Table 3

The modulation used on the preamble is in section 8.5.9.4.3 of the IEEE802.16a.

2.1.2.1 Downlink Sub-Channels Carrier Allocation

Each Sub-Channel is composed of 48 carriers, and is an independent entity in the base-band processing (each sub-channel data is randomized, encoded and interleaved separately, therefore it can be decoded separately).

The sub-channel indices are formulated using a Reed-Solomon series, and is allocated out of the data sub-carriers domain. The data sub-carriers domain includes 48*32=1536 carriers, which are the remaining carriers after removing from the carrier's domain (0-2047) all possible pilots and zero carriers (including the DC carrier).

After allocating the data sub-carriers domain the procedure specified in section 8.5.6.1.2 of the IEEE802.16a.

2.1.3 Allocation of sub-channels for DL MAP, and logical sub-channel numbering The minimal allocation of sub-channels for a sector (if the sector is used) is 3.

2.2 Up-Link

The following section defines the uplink transmission and symbol structure. The uplink follows the downlink model, therefore it also supports up to 3 sectors. Two formats of transmission in the uplink are supported:
Regular Sub-Channel of 53 carriers (32 Sub-Channels overall)
Mini Sub-Channel of 21/22 carriers (80 mini Sub-Channels overall)

Each transmission uses 48 symbols as their minimal block of processing, each new transmission commences with
a preamble (which is modulated on the allocated Sub-Channels only), allocations of sub-channels to users are done with the granularity of one Sub-Channel/mini Sub-Channel.
   2.2.1 Symbol Structure

The symbols structure supported in the uplink are specified hereafter.

2.2.1.1 Symbol Structure for Regular Sub-Channel

The symbol structure shall follow section 8.5.6.1 of the IEEE802.16a. 2.2.1.2 Symbol Structure for Mini Sub-Channel

The regular Sub-Channel in the DL shall be further divided to create the mini sub-channels, every to adjunct sub-channels (where the first one is the even sub-channel) shall be divided into 5 mini sub-channels.

The 106 carriers will be divided into 5 groups, 4 of them containing 21 carriers and the last containing 22 carriers. In each mini sub-channel 16 carriers are allocated for data and the rest are allocated as pilots.

The carriers which obey the following formula, are allocated to one mini sub-channel:

where:

defines carrier of sub-channel, as defined in 8.5.6.1.2 of the IEEE802.16a
defines mini sub-channel, 0 . . . 4.

The overall numbering of the mini sub-channels shall start from the first two sub-channels divided into 5 mini sub-channels and follow each two adjunct sub-channels which are divided, for a total of 80 mini sub-channels numbered 0 . . . 79.

FIG. 10: Mini Sub-Channel (of 21 carriers) organization and structure

FIG. 11: Mini Sub-Channel (of 21 carriers) organization and structure

The structure proposed will enable a module 5 frame structure, with maximum frequency diversity.

2.2.1.3 Burst Structure Using Regular Sub-Channels

The burst structure consists of the preamble and one time symbol following it as the basic structure. Allocating more sub-channels or/and time symbols could expand the burst; in any case the preamble is transmitted at the beginning of the burst on all allocated sub-channels.

This is depicted in FIG. 12.

FIG. 12 illustrates Burst Structure using regular sub-channel

2.2.1.4 Burst Structure Using Mini Sub-Channels

The burst structure consists of the preamble and 3 time symbols following it as the basic structure. Allocating more sub-channels or/and multiples of 3 time symbols could expand the burst; in any case the preamble is transmitted at the beginning of the burst on all allocated mini sub-channels.

Burst Structure Using Mini Sub-Channel

2.3 Base-Band Processing

The base-band processing includes the following processes:
Randomization
Encoding
Bit-Interleaving
Modulation

These processes are performed in the uplink and downlink in the same manner.

2.3.1 Randomization

As in section 8.5.9.1 specified in the IEEE802.16a.

2.3.2 Encoding

The coding method used as the mandatory scheme will be the tail biting convolutional encoding specified in section 8.5.9.2.1 and the optional modes of encoding in sections 8.5.9.2.2 and 8.5.9.2.2 shall be also supported, all sections as defined in the IEEE802.16a.

The encoding block size shall depend on the number of sub-channels/mini sub-channels allocated to the current transmission. Concatenation of a number of sub-channels/mini sub-channels shall be performed, with the limitation of not passing the largest block of encoding defined in section 8.5.9.2 of the IEEE802.16a. Therefore, table yy specifies the encoding block size and sequence used for different allocations and modulations.

2.3.2.1 Tail-Biting Convolutional Encoding

The convolutional encoding scheme is specified in section 8.5.9.2.1 (without the RS encoding part) specified in the IEEE802.16a. Table 5 defines the original sizes of the useful data payloads to be encoded in relation with the selected modulation type and encoding rate.

2.3.2.2 Block Turbo Code (BTC)

The BTC scheme is specified in section 8.5.9.2.2 specified in the IEEE802.16a.

The parameters used for the encoding process shall follow tablex

2.3.2.3 Convolutional Turbo Code (CTC)

The BTC scheme is specified in section 8.5.9.2.3 specified in the IEEE802.16a.

The parameters used for the encoding process shall follow tablex

2.3.3 Bit-Interleaving

Using the same scheme as defined in the IEEE802.16a with the parameters defined in table xx.

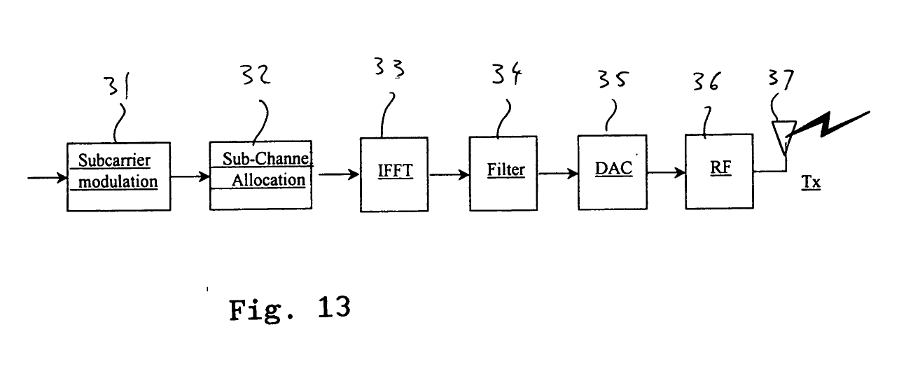

FIG. 13 details the structure of a wideband mobile transmitter, including:
subcarrier modulation unit 31,
sub-channel allocation unit 32,
IFFT (Inverse Fast Fourier Transform) unit 33—also includes a parallel to serial unit.
filter 34
DAC (digital to analog converter) 35
RF (radio frequency) transmit unit 36
antenna 37—a common antenna may be used for transmit and receive.

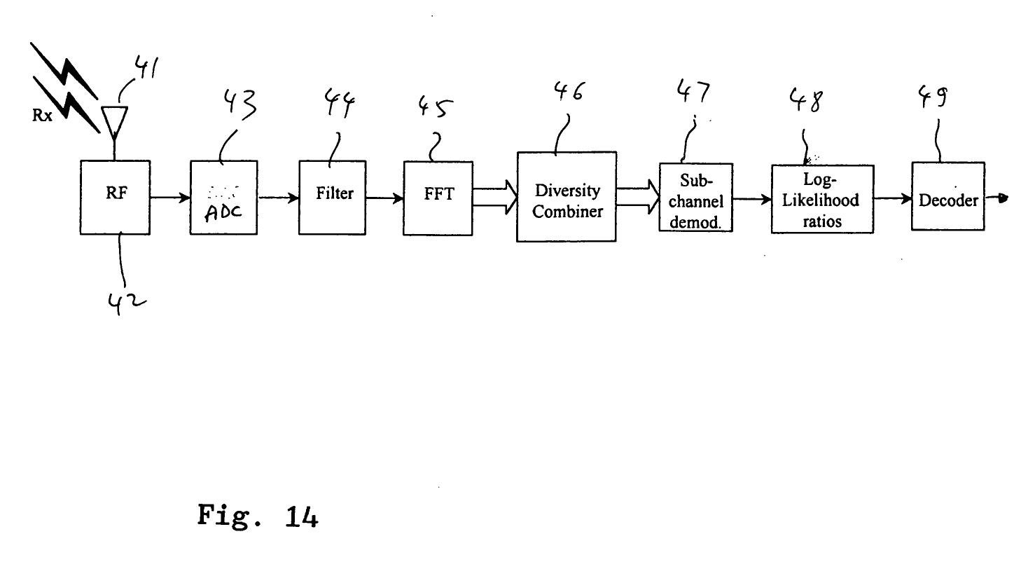

FIG. 14 details the structure of a wideband mobile receiver, including:
antenna 41—a common antenna may be used for transmit and receive.
RF (radio frequency) receive unit 42
ADC (analog to digital converter) 43
filter 44
FFT (Fast Fourier Transform) unit 45—also includes a serial to parallel unit
diversity combiner 46
subchannel demodulator 47
Log-likelihood ratios unit 48
decoder 49

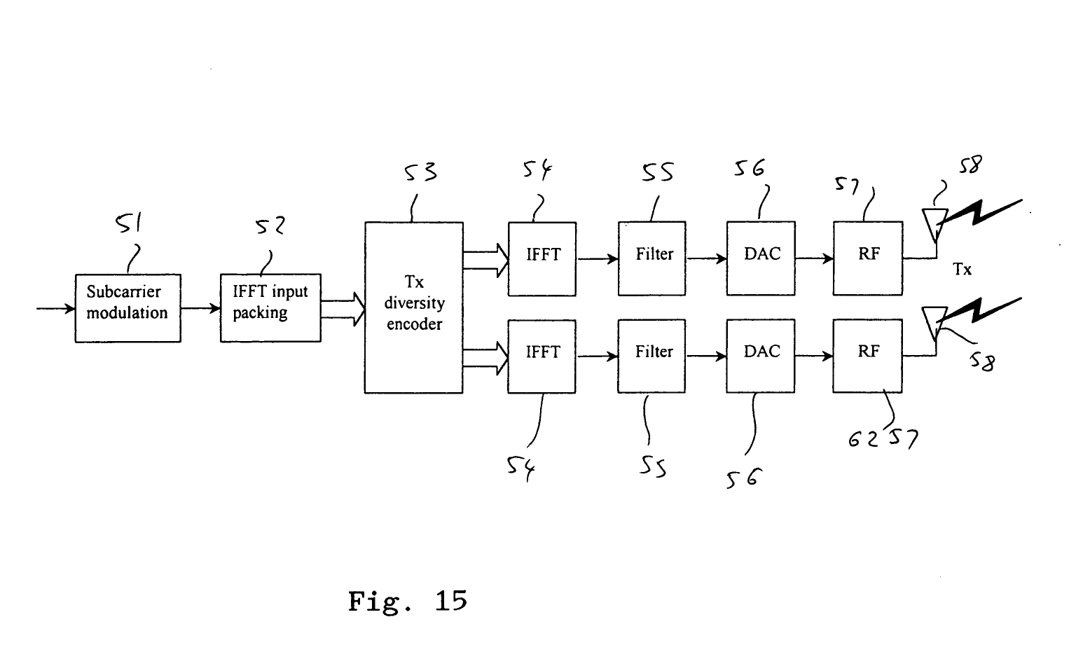

FIG. 15 details the structure of a wideband base station transmitter, including:
subcarrier modulation unit 51
IFFT input packing unit 52
transmit diversity encoder 53
IFFT (Inverse Fast Fourier Transform) units 54
filters 55
DAC (digital to analog converter) 56
RF (radio frequency) transmit units 57
antennas 58

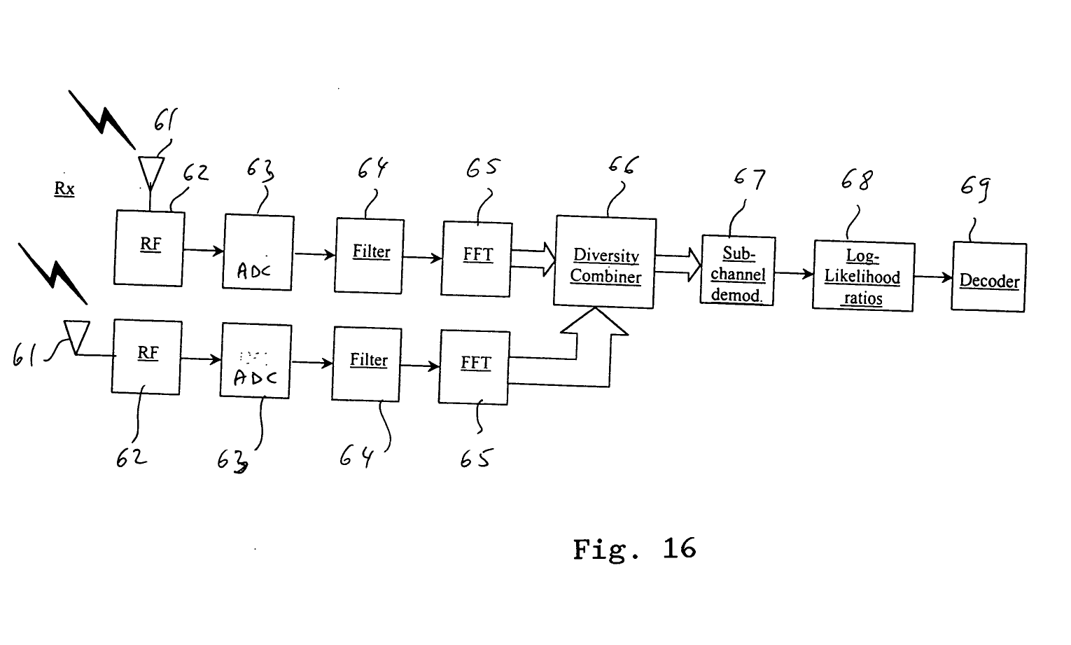

FIG. 16 details the structure of a wideband base station receiver, including:
antennas 61, which may be located at two different base stations
RF (radio frequency) receive units 62
ADC (analog to digital converters) 63
filters 64
FFT (Fast Fourier Transform) units 65
diversity combiner 66
subchannel demodulator 67
Log-likelihood ratios unit 68
decoder 69

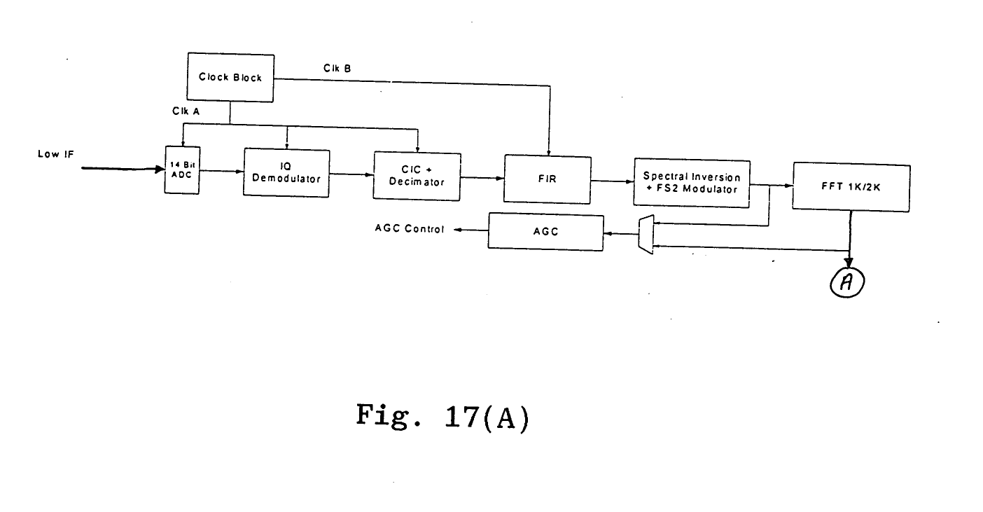

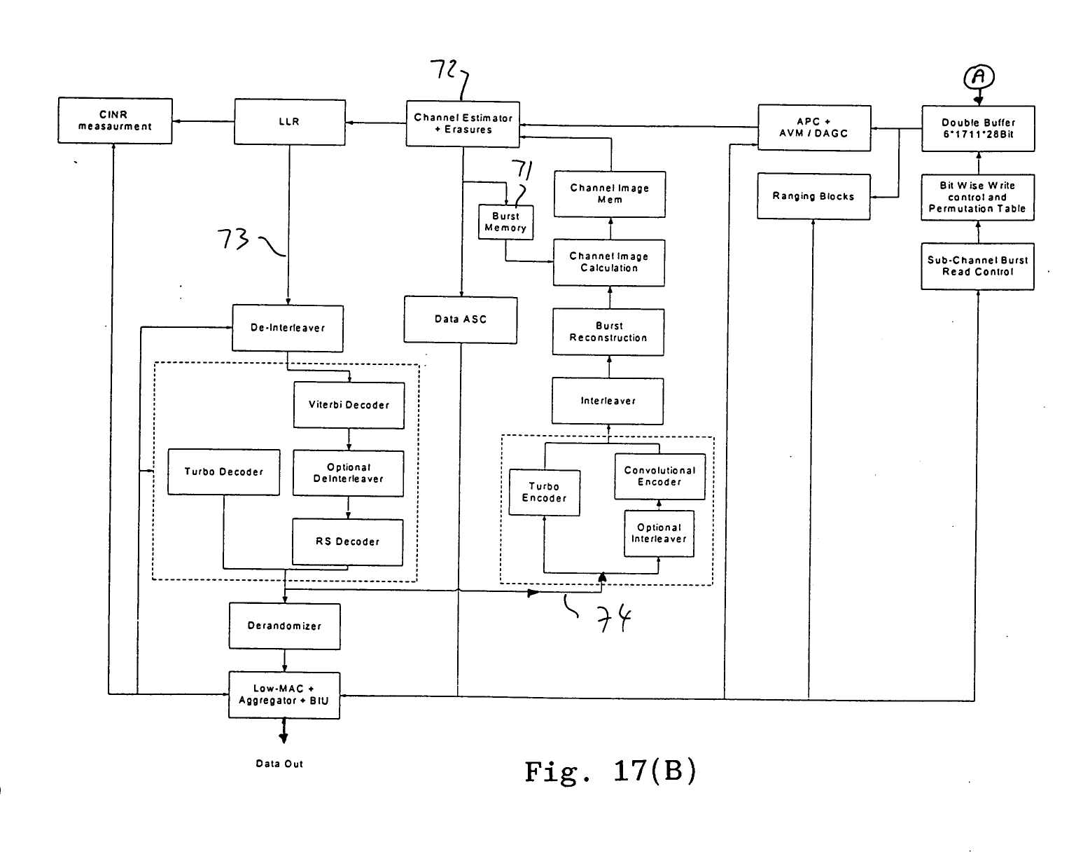

FIGS. 17(A) and 17(B) detail error correcting system.

Prior to summing two channels, preferably channel estimation and correction is performed. FIGS. 12(A) and 12(B) details a system for implementing channel estimation and correction.

Method of Operation:

1. The signal is received and undergoes receiver stages as detailed.

2. A digital memory 71 holds a prior channel estimate value, for example as measured in a preamble or a historic value.

3. The above estimate is used for channel correction in unit 72

4. The signal is further processed/demodulated, including a deinterleaver followed by a Turbo decoder or Viterbi decoder in path 73.

5. The demodulated, corrected data is output.

6. In a feedback path 74, the corrected data is modulated/encoded back, to reconstruct a corrected received signal (what it should have been).

7. An improved, updated channel estimate is computed, using the corrected data in feedback path 74. This estimate will be used for the next symbol to be received, which may also further update the channel estimate.

End of method.

Thus, the new system and method achieves a fast response together with good channel estimation and correction.

Note

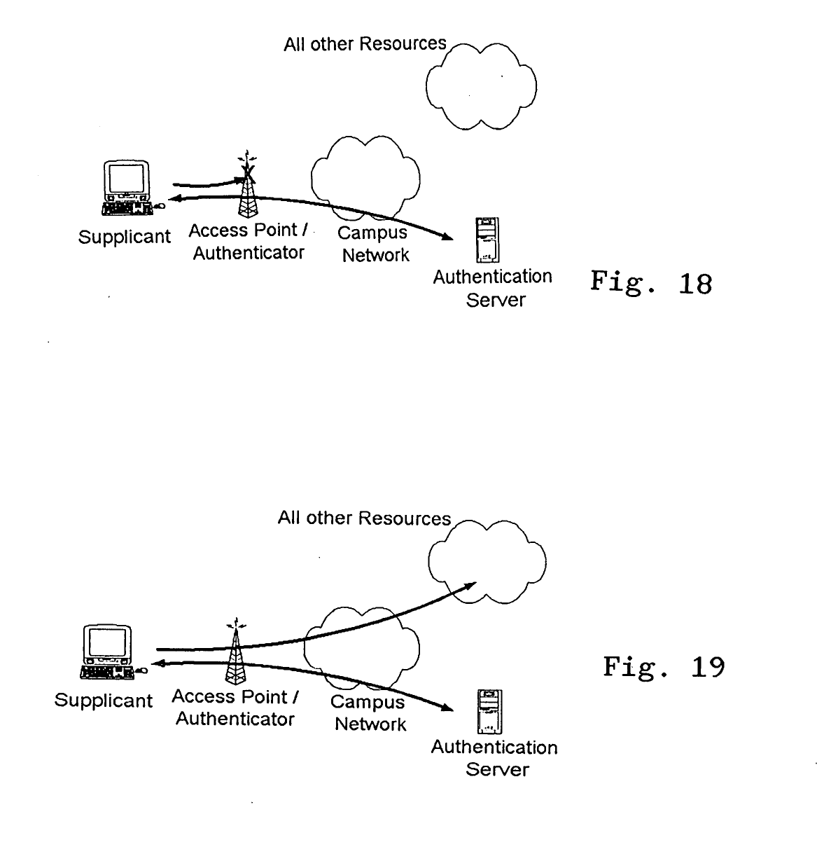

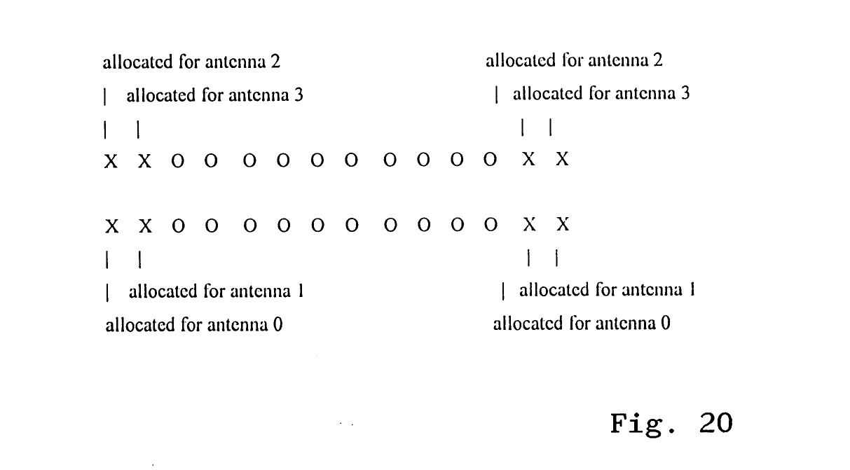

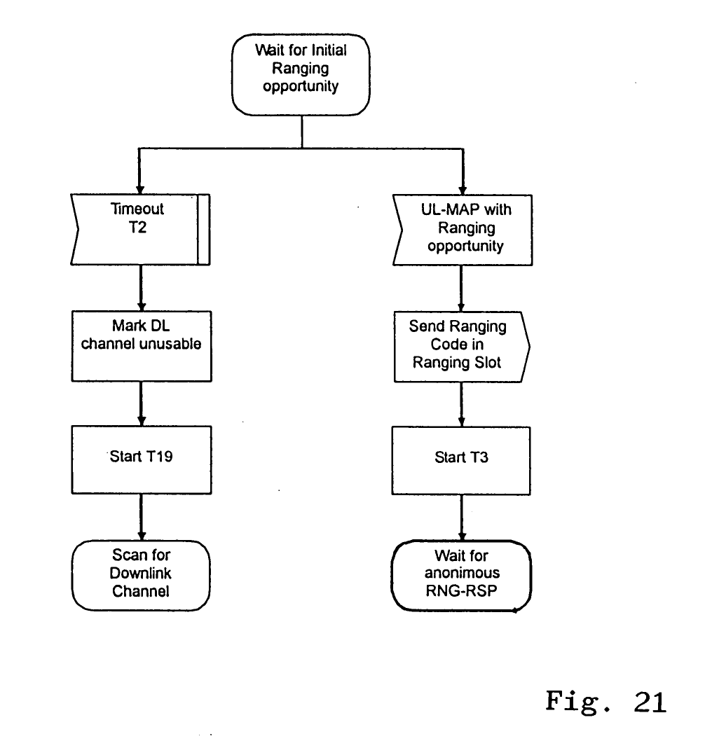

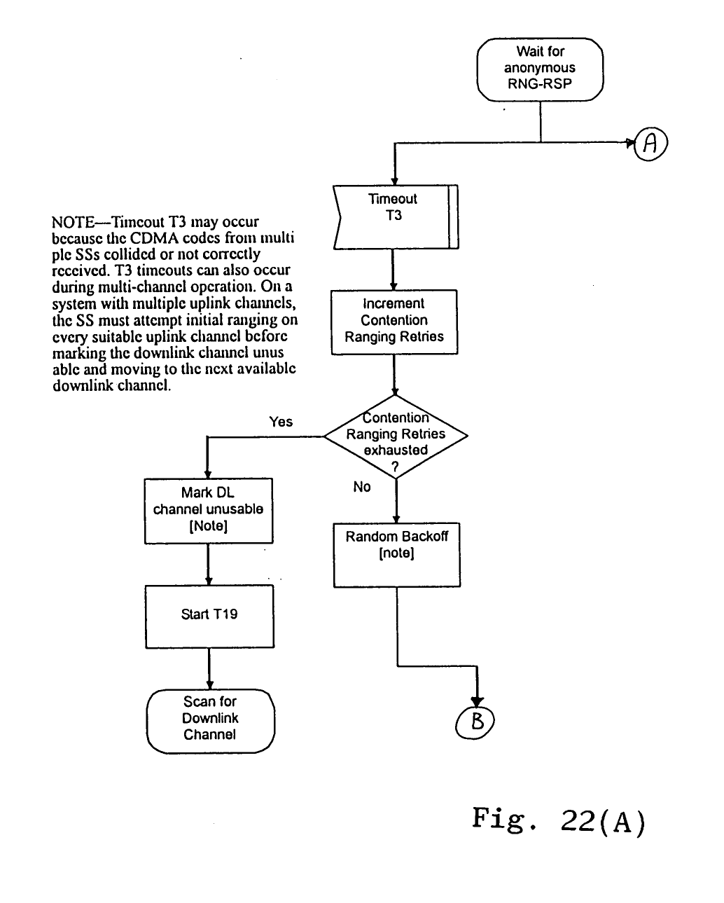

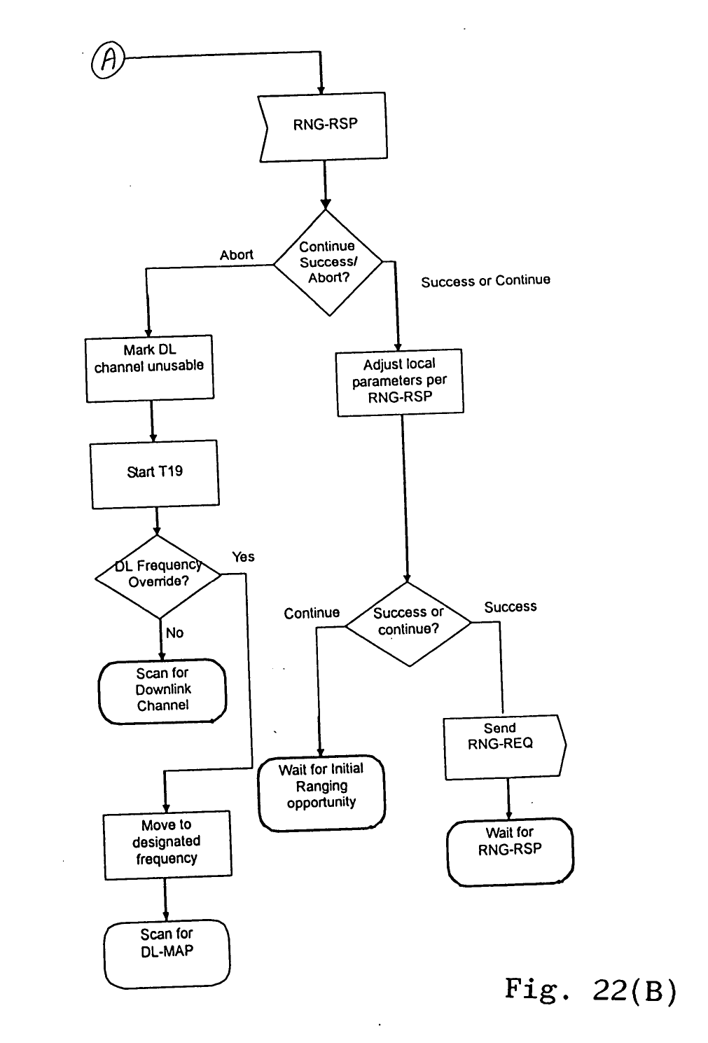

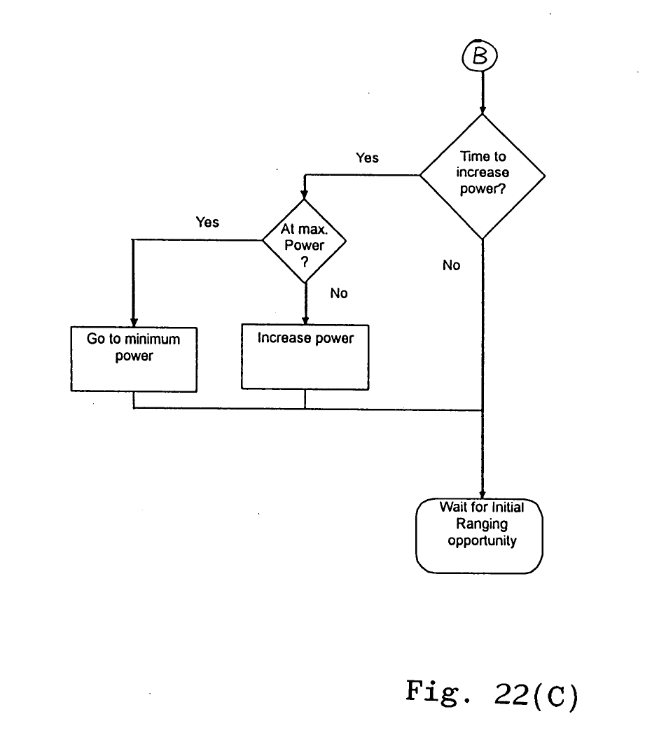

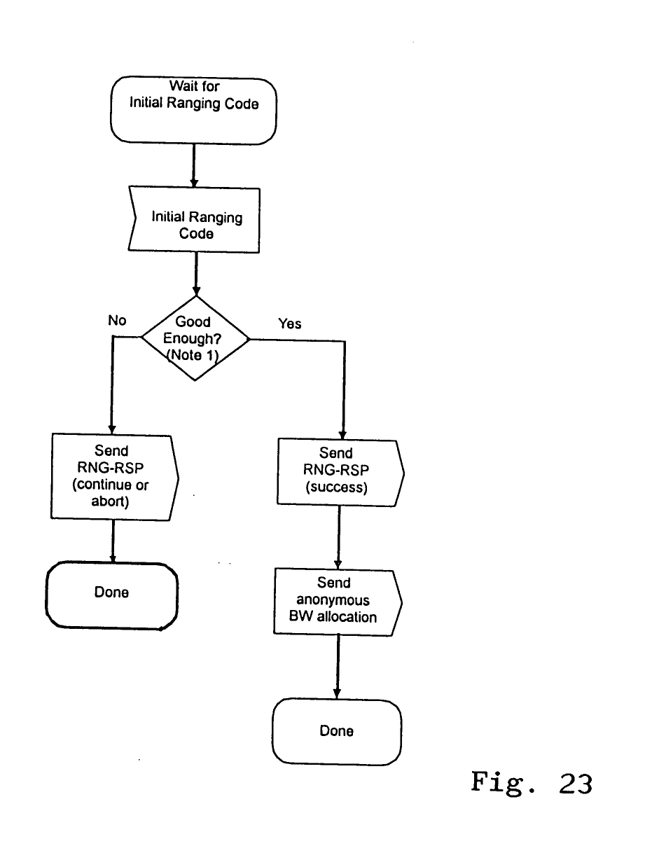

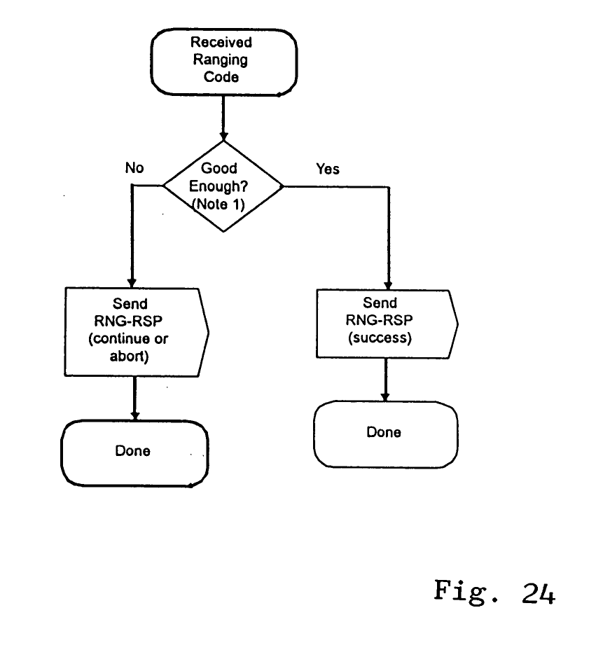

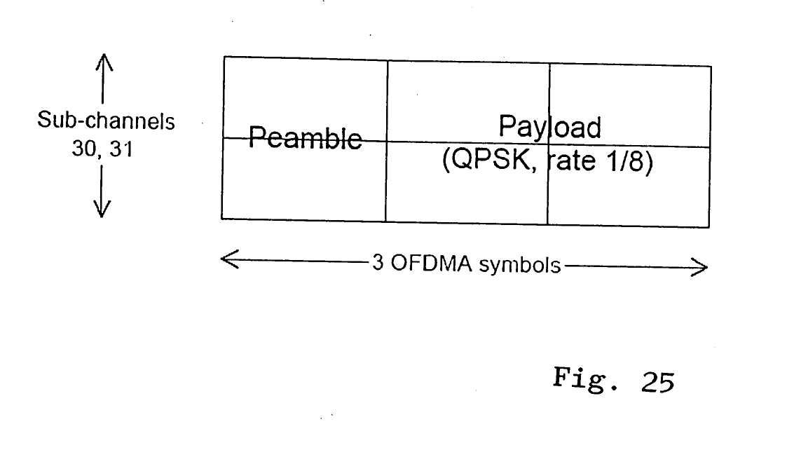

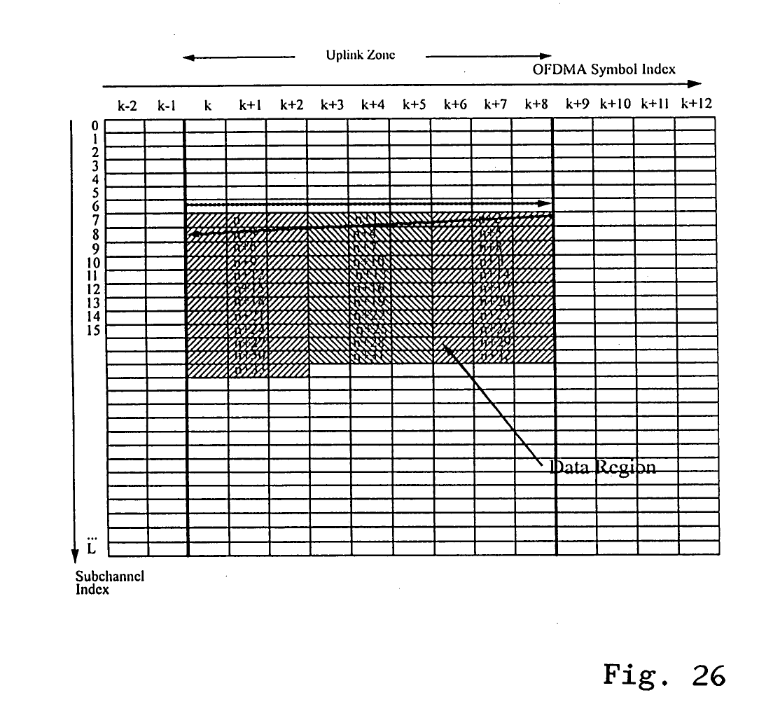

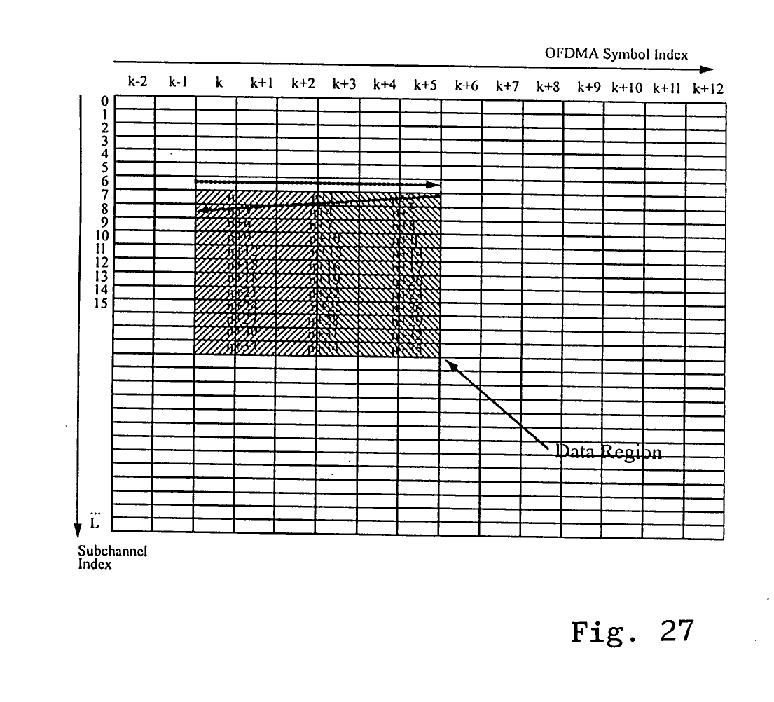

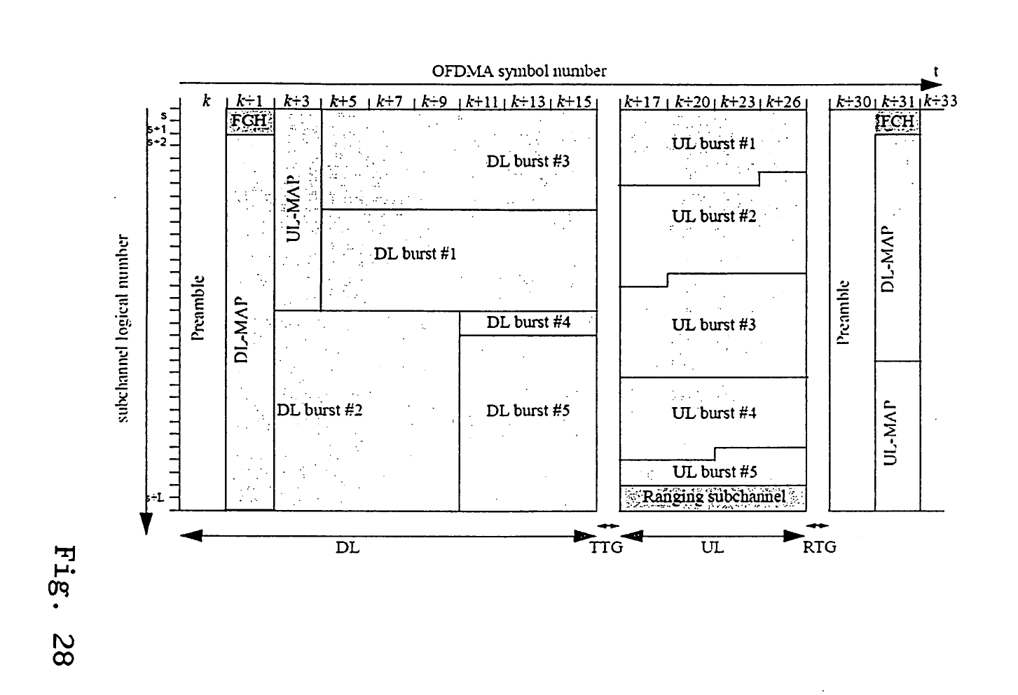

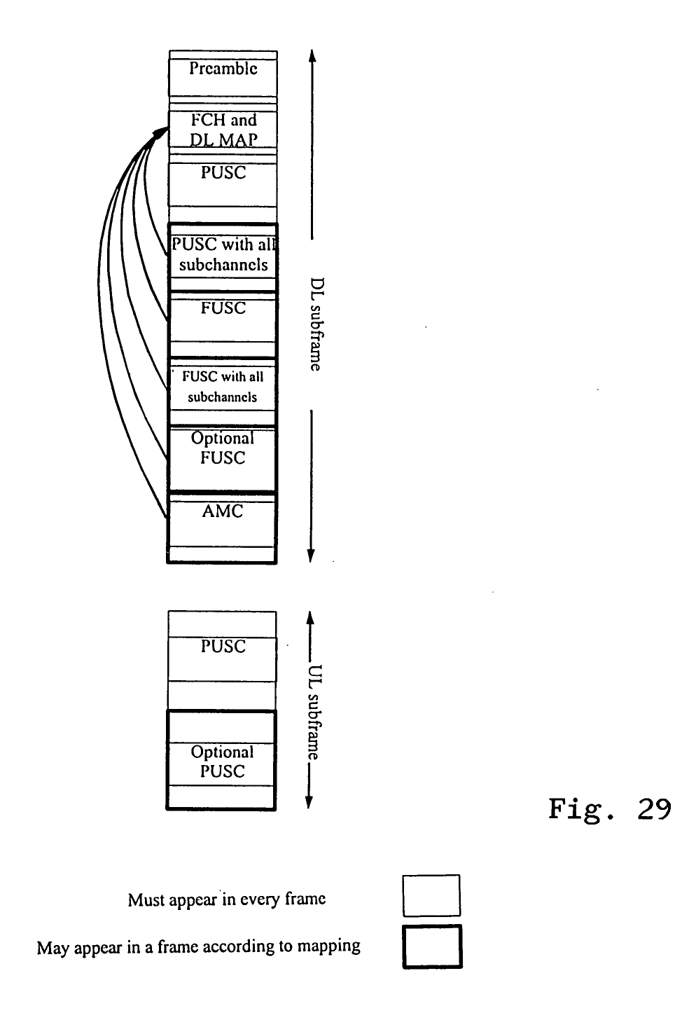

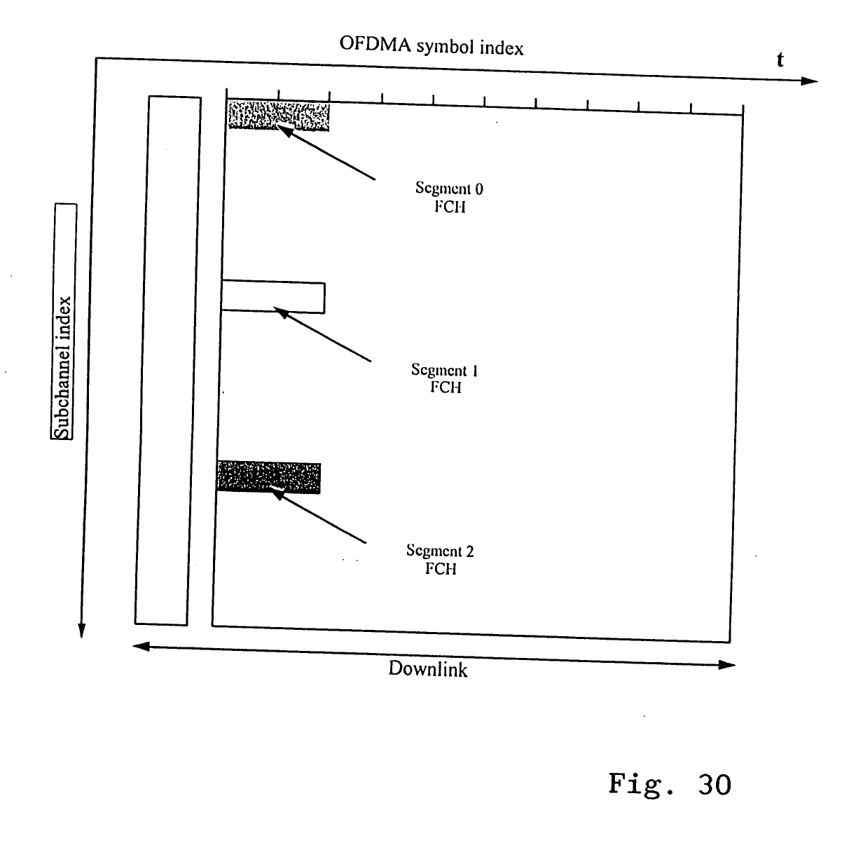

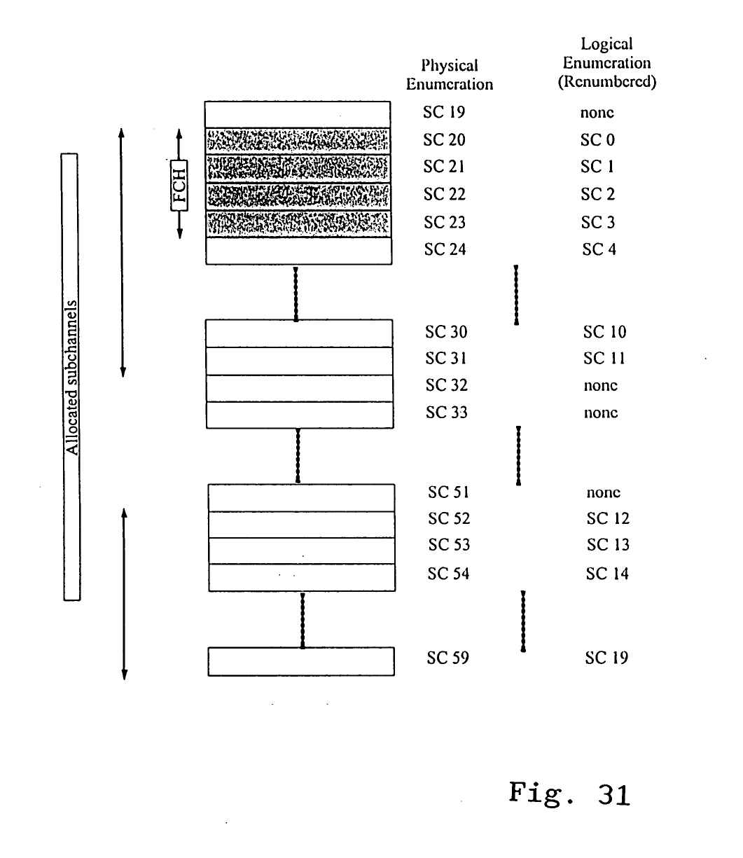

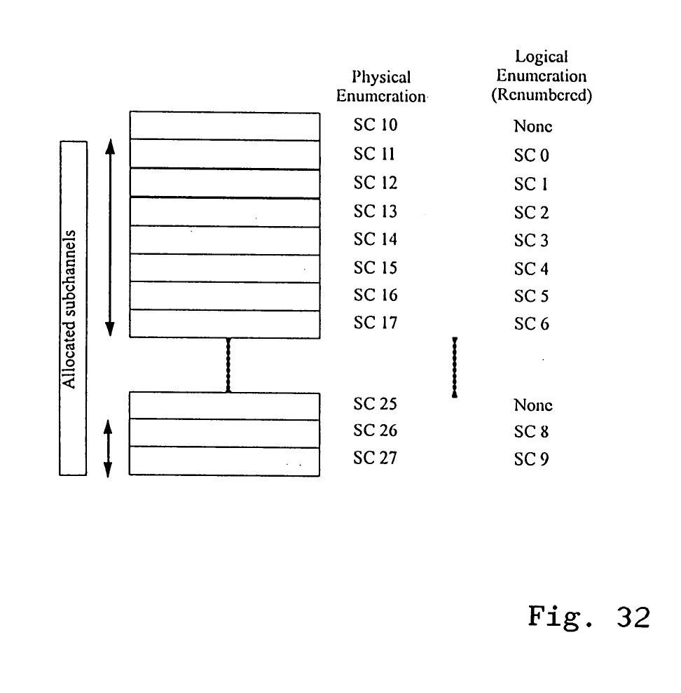

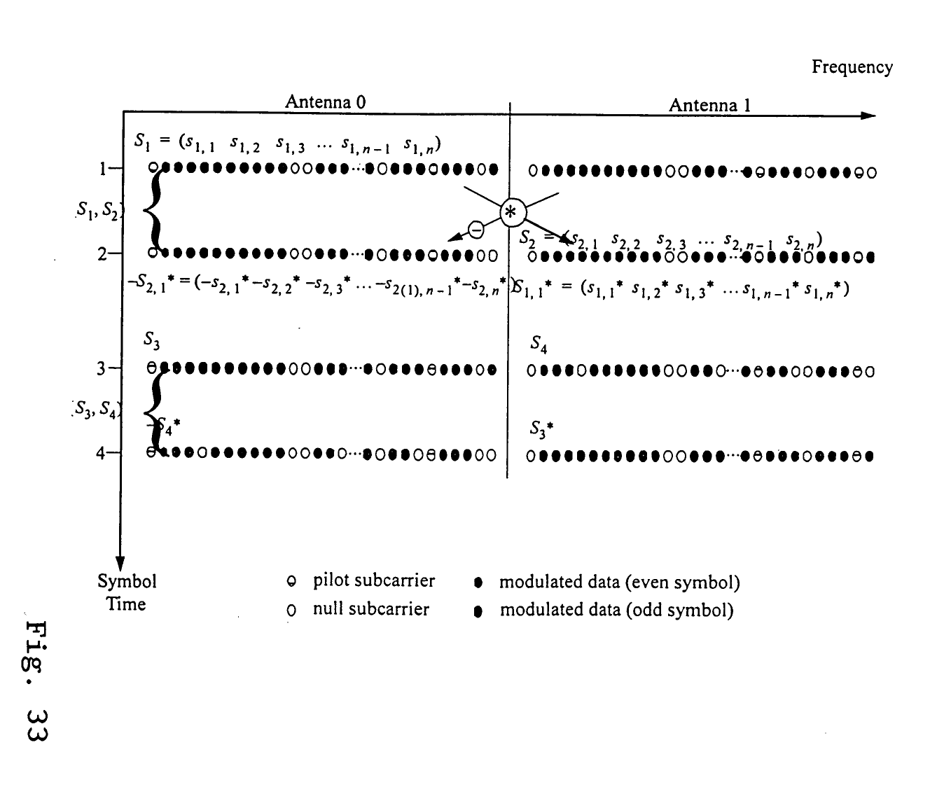

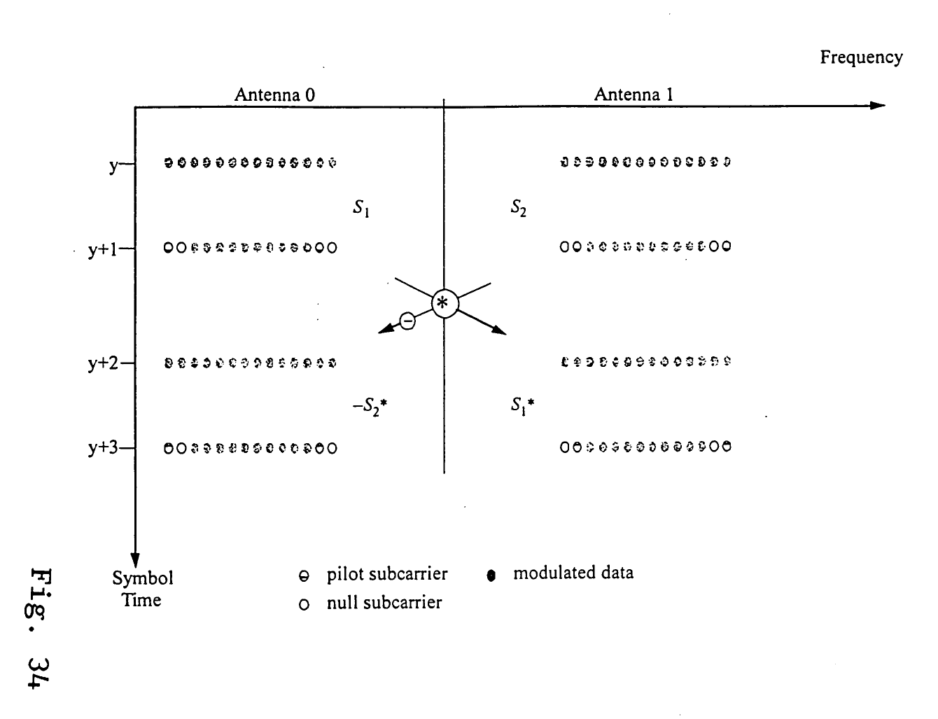

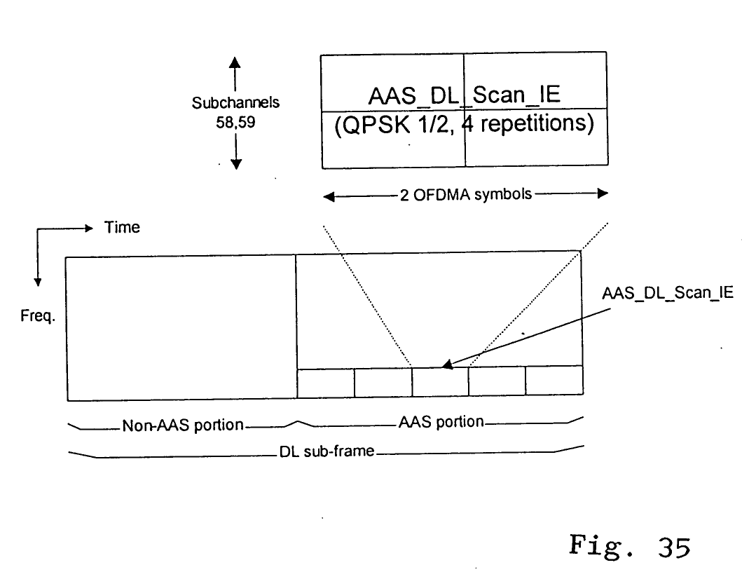

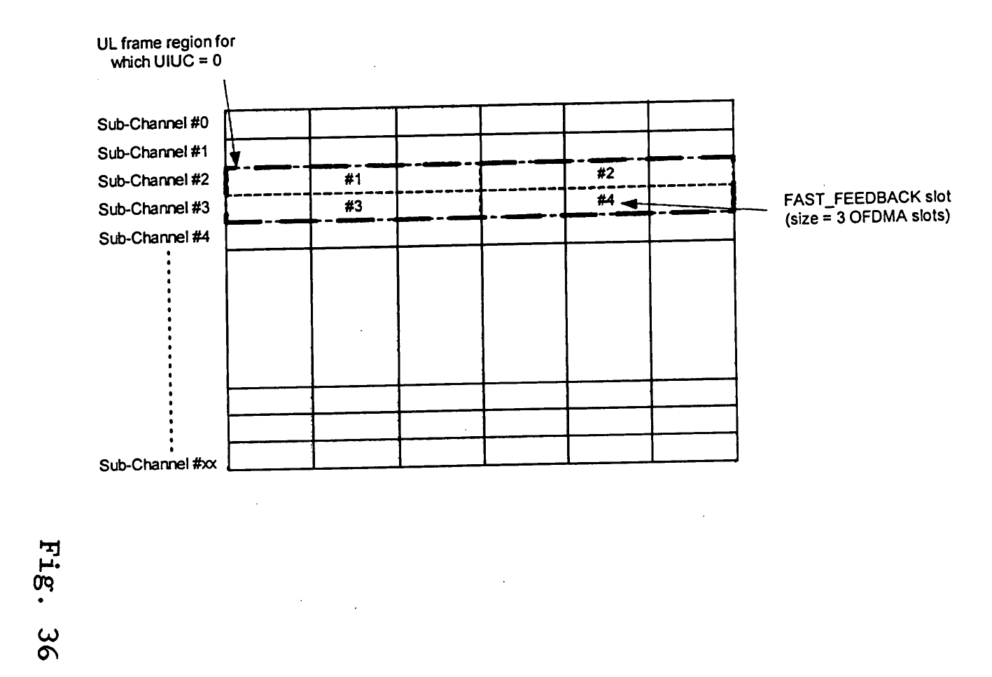

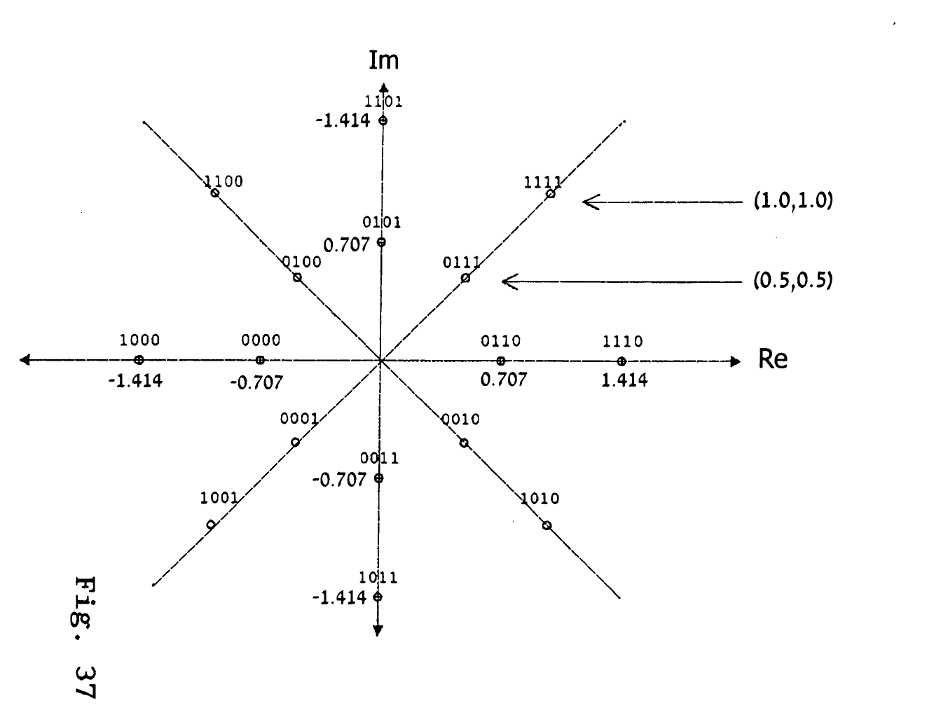

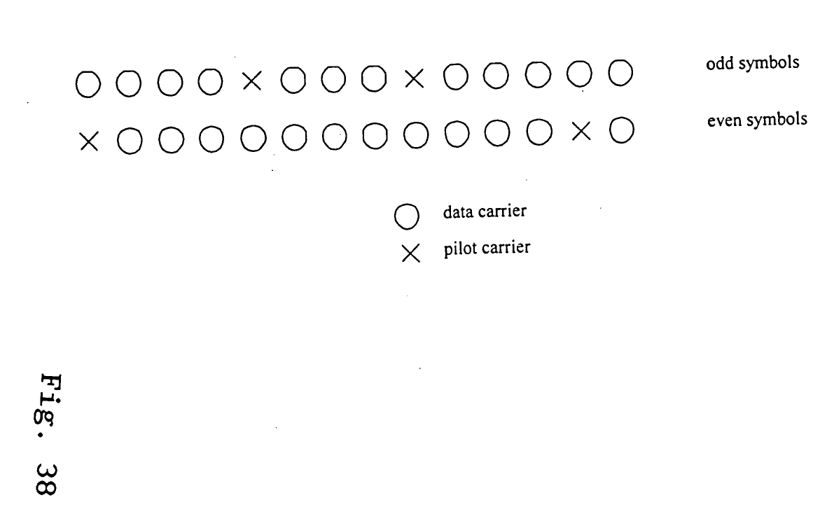

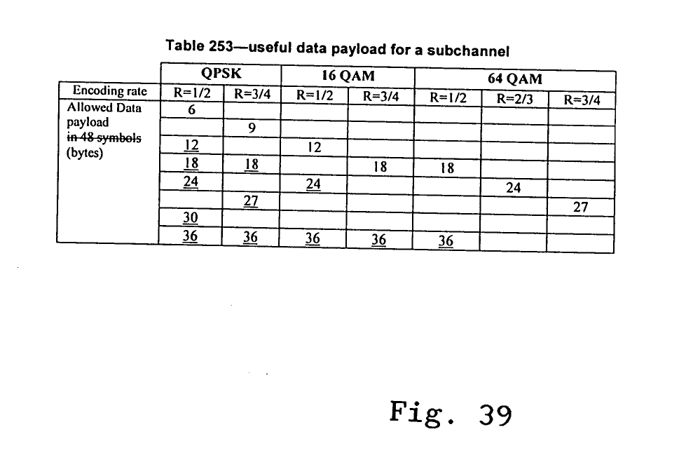

The description below, together with FIGS. 18 to 38, is an addition not contained in the priority Israel patent application and PCT application. Part of the material has been disclosed by the applicant before the IEEE 802.12 Working Group on Broadband Wireless Access, during the last 12 months.

It will be recognized that the present disclosure is but one example of an apparatus and method within the scope of the present invention and that various modifications will occur to those skilled in the art upon reading the disclosure set forth hereinbefore.

1. A Cellular network system wherein the physical layer as defined in 802.16a, comprising means for its optimization for mobile operators for improved Reliability, coverage, capacity, user location, fully scalability, and mobility from 2-6 Ghz, while working in a reuse of 1, wherein the same RF frequency is allocated to all sectors in the cell.

2. The Cellular network system according to claim 1, further including means for its operation in an Asynchronous mode with the system using any ref ck for creating the frames in that case each BS is using different permutations and collision between two users is happening throw frequency shift of the BSs and time shifts between frames, Inside the BS the sub channels are orthogonal, between BS/Sector the fact that each BS using different permutations per sub channel and different randomizers on the data create a controlled collision between the different BS users where few sub carriers collision are happening.

3. The Cellular network system according to claim 1, further using FEC, this enabling the system to operate with a reasonable capacity but with limited coverage like 90%, to achieve fast and low cost reasonable coverage with longer HO time.

4. The Cellular network system according to claim 3, wherein in TDD using the 802.16 time stamp to synchronize the frames and UL/DL timing between BS and different operators.

5. The Cellular network system according to claim 1, wherein including means for its operation in a synchronous mode with a more accurate reference clock being provided (by GPS for example) and the BS is synchronized by frames and by OFDM symbols.

6. The Cellular network system according to claim 5, wherein using higher FFT sizes, the frame number is synchronized by GPS or time stamp, to achieve orthogonality between sub carriers in the BS/Sector and between different neighbors BS/sectors.

7. The Cellular network system according to claim 1, wherein including means for its operation in a Coordinated Synchronous mode wherein permutations and collisions and averaging interferences from other cells cause limitations on the use of high QAM modulations, which sometimes can increase capacity up to three times (64 QAM instead QPSK).

8. The Cellular network system according to claim 7, wherein using the same permutations for a group of BS/sectors and a sector/BS are coordinate sub channels division between them by communicate through the backbone, to increase the capacity by factor of 1.5 on the same coverage area with a probability higher than 99%.
